(19) United States
(12) Patent Application Publication
(10) Pub. No.: US 2014/0019777 A1
(43) Pub. Date: Jan. 16, 2014

(54) POWER DATA COMMUNICATION ARCHITECTURE

(71) Applicants: Tsun-Te SHIH, New Taipei City (TW); Tsung-Chun CHEN, New Taipei City (TW); Kuang-Lung SHIH, New Taipei City (TW)

(72) Inventors: Tsun-Te SHIH, New Taipei City (TW); Tsung-Chun CHEN, New Taipei City (TW); Kuang-Lung SHIH, New Taipei City (TW)

(21) Appl. No.: 13/546,507

(22) Filed: Jul. 11, 2012

(51) Int. Cl. G06F 1/26

(52) U.S. Cl. 713/300

(57) ABSTRACT

A power data communication architecture located in an electronic apparatus includes at least a power supply unit, a data communication control unit and a motherboard. The power supply unit includes a power source management unit to generate at least one corresponding working parameter based on operating states of the power supply unit. The data communication control unit includes at least one power source management connection port to get the working parameter of the power supply unit and a buffer memory unit to store the working parameter. The motherboard is electrically connected to the buffer memory unit to read the working parameter saved therein.

### FIELD OF THE INVENTION

The present invention relates to power data communication architecture and particularly to power data communication architecture for an electronic apparatus equipped with power supply units.

### BACKGROUND OF THE INVENTION

Advance of computer technology has enabled computer systems to provide a wide variety of functions in response to users' requirements, such as data processing or recreational activities. They need to continuously process huge and complex information, and require stable and great amount of power supply. To prevent abrupt power outage or surge caused by switching to backup power that might damage expensive and complex electronic apparatus and result in instant loss of processing information, advanced computer systems generally adopt N+M redundant power supply system to maintain normal operation without interrupting power supply. N represents the number of combined power supplies required to support the total power load value of the electronic apparatus, while M indicates the allowable number of dysfunctional power supplies. N [symbol] 1, and M [symbol] 1. A redundant power supply system includes N+M sets of power supplies. Each power supply includes a standby power unit to provide standby DC power and a main power unit to output DC power in a power on state. At present many types of redundant power supply systems have been developed to enhance backup or fault tolerance function. For instance, U.S. Pat. No. 7,394,674 provides a backup power supply with parallel AC power source and DC power source. It adopts a dual-power source input design to continuously supply DC power to electronic apparatus to maintain normal operation thereof when outage of any one power input source occurs.

Although adequate power can be provided by using the aforesaid N+M redundant power supply system in order to meet the requirement of increasing performances of computer system, a great amount of power sources is simultaneously consumed. Thus the importance of power source management system has gained growing awareness, especially under the prevailing trend of green and eco-friendly technology. At present the most commonly adopted power source management systems include the Advanced Power Management (APM) and the Advanced Configuration and Power Interface (ACPI). The conventional APM is predominantly controlled by a firmware based on Basic Input/Output System (BIOS), under which the input of commands or decisions is difficult. Furthermore, the power cannot be adjusted effectively with changes of the operation system. The ACPI is a new power source management technique. Users can perform power source management through the operation system and can inspect power source consumption status. As the ACPI employs the operation system that extensively controls hardware to replace the conventional power source management through the BIOS, the power source management efficiency can be effectively improved. Moreover, power source management of the ACPI can be incorporated with hardware to register and control the power loss status of many apparatus. The items being monitored are extensive, including the voltage of power supply, the temperature of motherboard and the rotational speed of air fans and the like.

However, in the architecture of the N+M redundant power supply system, if the motherboard is required to perform power source management among different power supplies, in order to obtain monitored power information from different power supplies, the firmware of the motherboard must be modified, or more electric contacts connected to a plurality of power supplies have to be provided to identify the power supplies. But such approaches cannot be simply adapted to the motherboard whose architecture has been finished already.

### SUMMARY OF THE INVENTION

The primary object of the present invention is to solve the problem of the conventional motherboard used on an N+M redundant power supply system that has to change firmware and hardware. To achieve the foregoing object, the present invention provides power data communication architecture located in an electronic apparatus. It includes at least a power supply unit, a data communication control unit and a motherboard. The power supply unit includes a power source management unit to generate at least one corresponding working parameter based on operating states of the power supply unit. The data communication control unit includes at least one power source management connection port to get the working parameter of the power supply unit and a buffer memory unit to store the working parameter. The motherboard is electrically connected to the buffer memory unit to read the working parameter saved therein.

In one embodiment the data communication control unit includes at least one first serial data line and at least one first serial clock line connected to the power source management unit.

In another embodiment the motherboard includes a second serial data line and a second serial clock line connected to the data communication control unit.

In yet another embodiment the working parameter is a voltage value of a DC power generated by the power supply unit.

In yet another embodiment the power source management unit is electrically connected to a temperature detection unit, and the working parameter is the interior temperature of the power supply unit.

In yet another embodiment the power source management unit is electrically connected to a cooling fan, and the working parameter is the rotational speed of the cooling fan.

In yet another embodiment the power supply unit includes a rectification filter unit connected to an external power source, a power factor correction unit connected to the rectification filter unit, a transformer, a pulse width control unit, a switch element and a rectification output unit.

In yet another embodiment the power supply unit is electrically connected to an external power source to convert and output a DC power to drive the electronic apparatus for operation.

In yet another embodiment the data communication control unit includes a micro-control unit electrically connected to the power source management connection port.

In yet another embodiment the power data communication architecture includes two power supply units each including a power source management unit to generate at least one corresponding working parameter based on the operating states of the power supply unit.

In yet another embodiment the data communication control unit includes two power source management connection ports connected respectively to the two power source management units.

In yet another embodiment the power data communication architecture further includes a multiplexer interposed between the two power supply units and data communication control unit. The multiplexer sends an enable signal to one of the two power source management units according to a control signal output from the data communication control unit. Then the power source management unit receives the enable signal and sends the corresponding working parameter to the power source management connection port.

In yet another embodiment the data communication control unit includes a data output port electrically connected to the buffer memory unit to output the working parameter to the motherboard.

In short, in the power data communication architecture of the invention, the power supply units and motherboard are interposed by a data communication control unit which can get and save the working parameters from different power supply units, and allow the motherboard at the rear end to read. Hence there is no need to change the software or firmware of the motherboard in response to different number of power supply units, and the motherboard can be used in an N+M redundant power supply system.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a circuit block diagram of a first embodiment of the power data communication architecture of the invention.

FIG. 2 is a circuit block diagram of a second embodiment of the power data communication architecture of the invention.

### DETAILED DESCRIPTION OF THE PREFERRED EMBODIMENTS

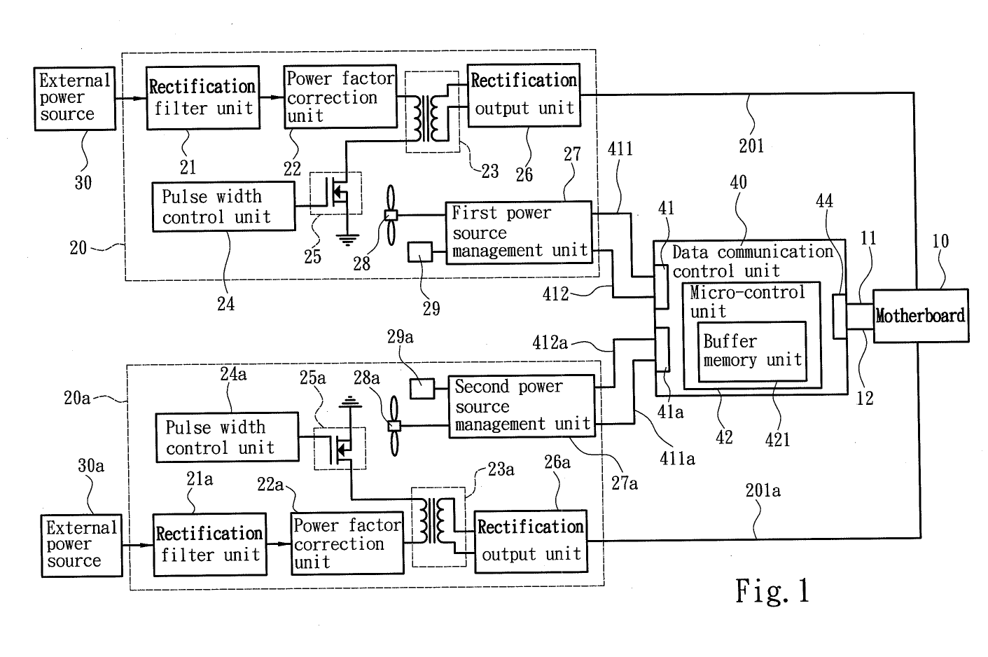

Please refer to FIG. 1 for the circuit block diagram of an embodiment of the power data communication architecture of the invention. It is located in an electronic apparatus which is a computer system in this embodiment. The computer system includes a motherboard 10 and a first power supply unit 20 and a second power supply unit 20a to output DC power. The motherboard 10 includes at least a central processing unit (CPU) and other electronic elements and circuits. The first and the second power supply units 20 and 20a can be integrated to form an N+M redundant power supply system, wherein N represents the number of the first power supply unit 20, M represents the number of the second power supply units 20a, and N [symbol] 1, while M [symbol] 0. In this embodiment N=1 and M=1. The first and the second power supply units 20 and 20a include respectively a rectification filter unit 21 and 21a connected to an external power source 30 and 30a, a power factor correction unit 22 and 22a connected to the rectification filter unit 21 and 21a, a transformer 23 and 23a, a pulse width control unit 24 and 24a, a switch element 25 and 25a, and a rectification output unit 26 and 26a. The external power sources 30 and 30a output external AC power which passes through the rectification filter units 21 and 21a and power factor correction units 22 and 22a. The power factor correction units 22 and 22a regulate the power factor and voltage of the external power through a voltage transformation power level.

The pulse width control unit 24 and 24a determine the duty cycle of the switch elements 25 and 25a, thereby regulate the coil current passing through the transformers 23 and 23a. Finally, the rectification output units 26 and 26a generate a DC power 201 and 201a, and transmit the DC power 201 and 201a to the motherboard 10. Moreover, the first and second power supply units 20 and 20a can be mutually electrically connected to at least one power integration control unit (not shown in the drawings). The first and second power supply units 20 and 20a also contain respectively at least one cooling fan 28 and 28a and one temperature detection unit 29 and 29a.

The first power supply unit 20 includes a first power source management unit 27 which generates at least one corresponding first working parameter based on operating states of the first power supply unit 20. The second power supply unit 20a includes a second power source management unit 27a which generates at least one corresponding second working parameter based on operating states of the second power supply unit 20a. The first and second working parameters can be voltage values of the DC power 201 and 201a, the interior temperature of the first and second power supply units 20 and 20a, or the rotational speeds of the cooling fans 28 and 28a.

The computer system further includes a data communication control unit 40 electrically connected to the first and second power supply units 20 and 20a, and the motherboard 10. The data communication control unit 40 includes a first power source management connection port 41 connecting to the first power source management unit 27 and a second power source management connection port 41a connecting to the second power source management unit 27a, and a micro-control unit 42 to receive the first or second working parameter from the first or second power source management connection port 41 or 41a. The micro-control unit 42 includes a buffer memory unit 421 to store the first or second working parameter. In addition, the data communication control unit 40 includes a data output port 44 electrically connected to the buffer memory unit 421 to receive the first or second working parameter saved in the buffer memory unit 421, and send to the motherboard 10 at the rear end. The motherboard 10 reads the first or second working parameter to perform power source management. When the motherboard 10 intends to monitor or manage the first and second power supply units 20 and 20a, it selects and reads the working parameters saved in the buffer memory unit 421 through software, and then the CPU on the motherboard 10 performs power source management on the first and second power supply units 20 and 20a. In this embodiment the data communication control unit 40 is connected to the first and second power supply units 20 and 20a, or the motherboard 10 via an internal integrated circuit (Inter-Integrated Circuit, I²C) bus. The first and second power source management connection ports 41 and 41a of the data communication control unit 40 include respectively first serial data lines 411 and 411a and first serial clock lines 412 and 412a connected respectively to the first and second power source management units 27 and 27a. The motherboard 10 includes a second serial data line 11 and a second serial clock line 12 connected to the data output port 44 of the data communication control unit 40.

The first serial data lines 411, 441a and second serial data line 11 transmit data and address in a two-way fashion. The first serial clock lines 412, 412a and second serial clock line 12 transmit clock in a two-way fashion.

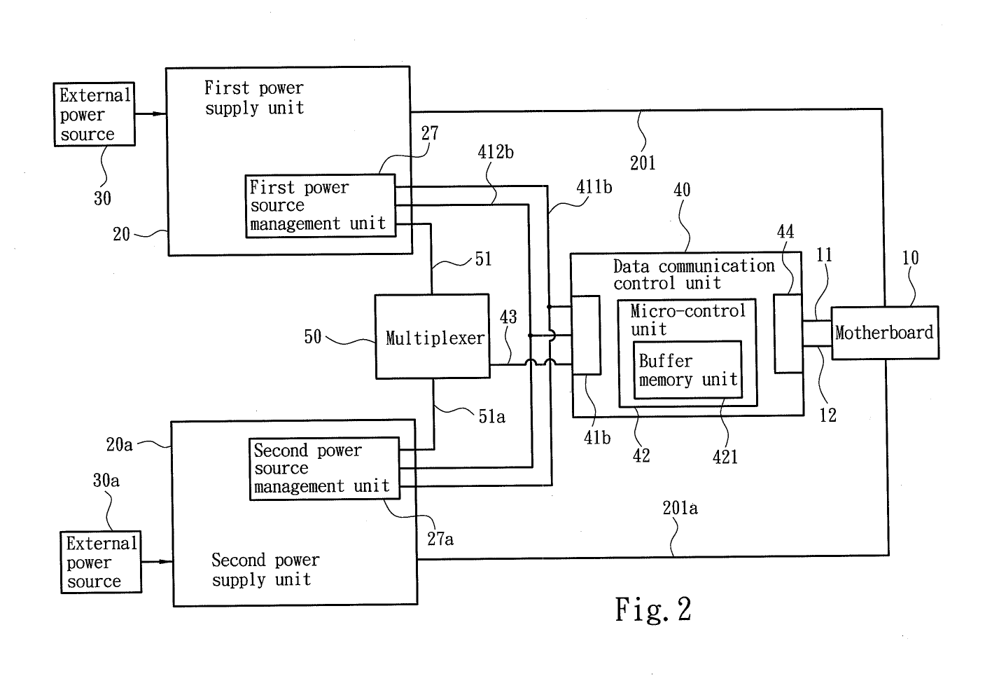

Please refer to FIG. 2 for the circuit block diagram of a second embodiment of the power data communication architecture of the invention. The data communication control unit 40 includes a power source management connection port 41b which further includes a first serial data line 411b and a first serial clock line 412b connected to the first power source management unit 27 and second power source management unit 27a. A multiplexer 50 is interposed between the first and second power source management units 27 and 27a of the first and second power supply units 20 and 20a and the data communication control unit 40. The data communication control unit 40 outputs a control signal 43 to the multiplexer 50 which in turn outputs individually an enable signal 51 or 51a to the first power source management unit 27 of the first power supply unit 20 or the second power source management unit 27a of the second power supply unit 20a according to control timing. The first power source management unit 27 receiving the enable signal 51 or the second power source management unit 27a receiving another enable signal 51a transmits the corresponding first or second working parameter to the power source management connection port 41b via the first serial data line 411b and first serial clock line 412b.

The power data communication architecture of this invention, through the data communication control unit interposed between the motherboard and the power supply units, can save a plurality of working parameters of the power supply units first, and then the motherboard can receive the working parameters to perform power source management. Hence no change of firmware or adding of electric contacts on the motherboard is needed in response to different number of power supply units. Thus a single motherboard can be widely used in various applications.

While the preferred embodiments of the invention have been set forth for the purpose of disclosure, they are not the limitations of the invention. Modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A power data communication architecture located in an electronic apparatus, comprising:
at least one power supply unit including a power source management unit to generate at least one corresponding working parameter based on operating states of the at least one power supply unit;
a data communication control unit including at least one power source management connection port to get the at least one working parameter of the at least one power supply unit and a buffer memory unit to store the at least one working parameter; and
a motherboard electrically connected to the buffer memory unit to read the at least one working parameter saved in the buffer memory unit.

2. The power data communication architecture of claim 1, wherein the data communication control unit includes at least one first serial data line and at least one first serial clock line connected to the power source management unit.

3. The power data communication architecture of claim 1, wherein the motherboard includes a second serial data line and a second serial clock line connected to the data communication control unit.

4. The power data communication architecture of claim 1, wherein the at least one working parameter is a voltage value of a DC power generated by the at least one power supply unit.

5. The power data communication architecture of claim 1, wherein the power source management unit is electrically connected to a temperature detection unit, the at least one working parameter being an interior temperature of the at least one power supply unit.

6. The power data communication architecture of claim 1, wherein the power source management unit is electrically connected to a cooling fan, the at least one working parameter being a rotational speed of the cooling fan.

7. The power data communication architecture of claim 1, wherein the at least one power supply unit includes a rectification filter unit connected to an external power source, a power factor correction unit connected to the rectification filter unit, a transformer, a pulse width control unit, a switch element and a rectification output unit.

8. The power data communication architecture of claim 1, wherein the at least one power supply unit is electrically connected to an external power source to convert and output a DC power to drive the electronic apparatus for operation.

9. The power data communication architecture of claim 1, wherein the data communication control unit includes a micro-control unit electrically connected to the at least one power source management connection port.

10. The power data communication architecture of claim 1 further including two power supply units each including a power source management unit to generate at least one corresponding working parameter based on operating states of one of the two power supply units.

11. The power data communication architecture of claim 10, wherein the data communication control unit includes two power source management connection ports connected respectively to the two power source management units.

12. The power data communication architecture of claim 10 further including a multiplexer interposed between the two power supply units and the data communication control unit, the multiplexer sending an enable signal to one of the two power source management units according to a control signal output from the data communication control unit, the power source management unit receiving the enable signal and sending the corresponding working parameter to the at least one power source management connection port.

13. The power data communication architecture of claim 1, wherein the data communication control unit includes a data output port electrically connected to the buffer memory unit to output the at least one working parameter to the motherboard.
